(19) United States
(12) Patent Application Publication
(10) Pub. No.: US 2002/0091633 A1
(43) Pub. Date: Jul. 11, 2002

(54) Facility and method for cellular data communication between merchants and credit processing agencies

(75) Inventor: Rod L. Proctor, Seattle, WA (US)

Correspondence Address: STOEL RIVES LLP, 900 SW FIFTH AVENUE, SUITE 2600, PORTLAND, OR, 97204-1268, US

(73) Assignee: Integrated Data Communications

(21) Appl. No.: 09/757,938

(22) Filed: Jan. 10, 2001

(51) Int. Cl. G06F 17/60

(52) U.S. Cl. 705/39

(57) ABSTRACT

A wireless financial transaction verification facility has a transaction information terminal for scanning credit cards and entering a purchase price, and communicates information in a first electronic format. A converter is connected to the terminal and operates to convert the information to a second format transmissible by a digital cellular network. A wireless communication device is connected to the converter, and operates to communicate with the network in the second format. At a central financial agency, a similar converter may convert the information from the digital wireless transmissible format to a different format. Reply communication with approval or other information may proceed by the same means.

### FIELD OF THE INVENTION

The present invention is directed to wireless communication, and more particularly to wireless data communication for verification of credit card purchases.

### BACKGROUND AND SUMMARY OF THE INVENTION

The use of credit cards for retail purchases is widespread. To ensure against fraud, merchants verify the legitimacy and capability of a purchaser by transmitting an identifying credit card number, a transaction monetary amount, and other information to a central agency associated with the card issuer. The issuer responds with an approval or denial of the transaction, based on whether the purchase is within the purchaser's available credit, and whether the card has been reported lost or stolen. Communication between the merchant and the issuer is by way of a merchant terminal connected via telephone lines to the issuer computer. The terminal includes what is essentially a modem that operates to convert digital data into audible tones transmissible over phone lines, and which may be demodulated and reconverted to the data by the recipient.

While useful for many merchants, other merchants seeking to accept credit cards do not have telephone lines available, and therefore may not accept credit cards. Such merchants include those at remote locations, those with temporary locations of operation, and those in other transitory circumstances where the wiring of telephones is impractical. Examples include: a small merchant at a seasonal craft fair, a large traveling entertainment production such as a circus or touring Broadway show, and wandering food and souvenir vendors at stadium events. For a merchant without telephone lines to accept a credit card, he may use a wireless telephone to make a voice communication with a human operator at the verification agency, reading the credit card number and purchase price information aloud, and listening for the operator to verbally issue an approval or denial. However, this introduces delay and inconvenience, increases operating costs of the agency, and risks that the spoken confidential information is overheard, leading to fraud.

While credit card terminals, with their card scanning transducers, keypads, and electronic displays are readily connected to conventional phone lines, they are incompatible with digital cellular networks. The technical reason that the terminal cannot communicate over digital cellular networks is the “vocoders” in the cellular voice transmission path. These vocoders compress the voice signals, making more conversations possible in the same bandwidth, thereby conserving spectrum. While effective for transmitting spoken words, the compression responds to modem tones in a way that corrupts the data carried therein, and renders the result unusable. The terminal modem used to send data over the wire-line network is not able to send data through the cellular voice path. Some digital cellular networks have data paths separate from the voice path that could be used to send data to a selected receiving location. However, even in these cases, the terminal is not able to connect to the mobile data ports of these phones.

The present invention overcomes the limitations of the prior art by providing a wireless financial transaction verification facility that has a transaction information terminal for scanning credit cards and entering a purchase price, and which communicates information in a first electronic format. A converter is connected to the terminal and operates to convert the information to a second format transmissible by a digital cellular network. A wireless communication device is connected to the converter, and operates to communicate with the network in the second format. At a central financial agency, a similar converter may convert the information from the digital wireless transmissible format to a different format. Reply communication with approval or other information may proceed by the same means.

### BRIEF DESCRIPTION OF THE DRAWINGS

FIG. 1 is a high-level block diagram showing the environment in which the facility preferably operates.

### DETAILED DESCRIPTION OF A PREFERRED EMBODIMENT

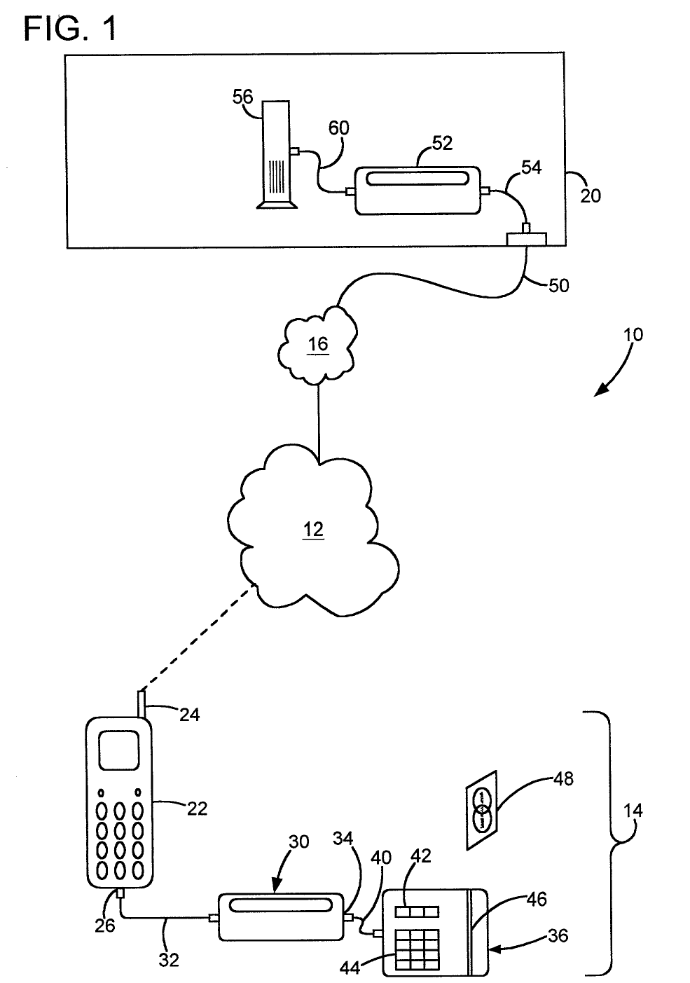

FIG. 1 shows a financial transaction verification system 10 including a wireless or cellular network 12 with a user system connected to the network. The cellular network is connected to a conventional telephone system 16. A central verification facility 20 such as a bank, credit card issuer, or agency is connected to the system 16.

The user system includes a digital cellular telephone 22 having an antenna 24 communicating with the cellular network 12. The phone includes circuitry that encodes vocal communications digitally, in a highly compressed format that allows a conversation to be transmitted with limited bandwidth. The circuitry also includes receiving capabilities that receive such a digital stream, and convert it into an audible facsimile of the original words spoken by a caller with whom the user is speaking. The phone 22 includes a conventional ear piece and microphone, as well as a supplementary connector 26 of the type used for communication with accessories such as hands-free headsets. The connector has several lines, some of which are a remote analog microphone input and an analog speaker output.

A converter 30 is connected to the phone connector via a cable 32. The converter is described in U.S. Pat. No. 6,144,336, by Dan Preston, et al., entitled SYSTEM AND METHOD TO COMMUNICATE TIME STAMPED, 3-AXIS GEO-POSITION DATA WITHIN TELECOMMUNICATION NETWORKS, issued Nov. 7, 2000, and which is incorporated herein by reference.

The converter includes a connector 34, to which a conventional credit card verification terminal 36 is connected via a cable 40. The terminal 36 includes an alphanumeric display 42 for displaying text to a user based on encoded signals received via cable 40. The terminal 36 includes a keyboard or other input device 44 for the user to enter transaction information to be encoded and transmitted via the cable to the converter. A magnetic credit card reader slot 46 is an input device that reads unique data encoded on a magnetic strip on a purchaser's credit card 48. In alternative embodiments, the credit card may include data encoded by other means, such as a memory chip that records information beyond identifying the card, including balance and available credit. Other alternative terminals may collect purchaser information by other means, including biometric data contained in fingerprints. In addition, references to “credit cards” is intended to include all means for purchases and other financial transactions, including debit cards, bank draft verification, and other means of credit extension in which information or qualification asserted by a purchaser needs to be verified.

The terminal 36 operates conventionally, and includes what is essentially a modem that converts the scanned or entered data to be sent from a digital form to a modulated tonal pattern transmissible via conventional telephone lines; it further operates to receive such a modulated audio signal and convert it to digital form for display.

The central verification facility 20 is connected to the telephone network via phone lines 50. A converter 52 that is essentially functionally identical to converter 30 is connected via line 54 to line 50. A computer system 56 is connected via line 60 to the converter 52, and includes or connects to a financial database containing information about the purchaser's credit card, credit history, account balance or available credit, and other financial status, including whether or not the credit card is listed as stolen. In alternative embodiments, a computer terminal permitting human operator involvement may be connected, for instances in which a judgement must be made about whether or not to approve a proposed purchase or transaction.

The converter 52 need not be a separately housed device, but may be included as an internal circuit board in existing systems, or integrated into the circuitry and or software of systems. As with the user system 14, the facility system 20 operates both for transmission and receiving of messages in text format.

The system in the facility 20 is shown in a simplified form to illustrate the preferred embodiment. As shown, it is connected to a telephone line that may have a special phone number for use by wireless terminal users. Routing hardware and or software between line 50 and the converter 52 would analyze the characteristics of each call received to identify whether the call was a conventional inquiry from a standard terminal using a communication format via a wired line, or whether it was in the special encoded format generated by a converter 30. Based on this determination, the router directs calls to bypass the converter 52, and directs encoded calls to the computer 56 via the converter 52.

The system operates as follows: A merchant having a system 14 wishes to accept a customer's credit card 48. If the merchant system's components are not set up, the merchant connects the components as shown. The phone 22 is activated, and the verification system number is dialed by the merchant. Other phone functions also may be conducted by using the device keyboard 44. in any case, the terminal 36 is used to generate a communication for the center to receive. The communication may be a standardized inquiry identifying the customer's account number and purchase amount, possibly including other information such as PIN number, and other identifiers.

The message generated in the terminal 36 is modulated to an audible stream of tones, which are transmitted to the converter 30. The converter converts this signal into a data stream in encoded format that is readily transmitted via digital cellular networks, as described in the incorporated reference. The phone then transmits this encoded stream to a receiver node on the network 12, which transmits the stream via the conventional telephone network to the facility 20.

The facility identifies the stream as an encoded stream in the transmissible format, and if necessary, routes the call to the converter 52. The converter 52 converts the encoded stream into the modulated audible tone signal, which is demodulated by a modem in the computer 56, and processed. Upon processing the transmitted message, the computer generates a reply message. This may be a simple indication of approval or denial of a transaction, or may include other information such as whether a credit card has been stolen or requires confiscation. The return communication follows the same path as the original communication, being modulated by the modem in the computer 56, converted to the transmissible format by the converter 52, and transmitted via networks 16 and 12 to be received by the merchant's phone 22. The encoded stream is converted to a modulated pattern of tones by converter 30, which tones are demodulated into digital form by the terminal 36 for display to the user.

While the above is discussed in terms of preferred and alternative embodiments, the invention is not intended to be so limited. For instance, the component's of the merchant system 14 may be combined or integrated. All may be included in a single device, the telephone may incorporate the decoder circuitry, and/or the terminal may incorporate the decoder circuitry.

1. A method of verifying a financial transaction comprising:
receiving via a digital wireless network a merchant financial verification request in a first format;
identifying that the request is in the first format;
converting the request to a second format; and
after converting, analyzing the request to determine whether to transmit an authorization message.

2. The method of claim 1 including generating an authorization message in the second format, and converting the message to the first format for transmission via the network.

3. The method of claim 1 including a user engaging in the steps of:
inputting transaction information to an input device,
converting the information to a signal in the second format,
converting the signal in the second format to a signal in the first format, and
transmitting the signal to the network.

4. The method of claim 3 including the user converting a reply signal from the network from the first format to the second format, and from the second format to a text format.

5. The method of claim 1 including the steps of:
providing a wireless remote communication apparatus (“RCA”) having a vocoder for transmitting and receiving human voice content over a voice channel of the digital wireless communication network;
providing a call receiver apparatus (“CRA”) also capable of transmitting and receiving human voice content over a voice channel of the digital wireless communication network;
defining one or more control codes reserved for communication control signaling over the voice channel, each control code comprising one or more alpha-numeric characters;
establishing a digital voice channel connection between the RCA and the call receiver apparatus CRA;
in a first one of the RCA and the CRA, selecting one of the communication control codes for transmission to the other one of the RCA and the CRA;
in the first one of the RCA and the CRA, converting the selected control code into an audio tone representation;
in the first one of the RCA and the CRA, formatting the audio tones in a vocoder so as to form digital transmission data;
in the first one of the RCA and the CRA, transmitting the digital transmission data over the digital voice channel connection to the other one of the RCA and the CRA; and
in the other one of the RCA and the CRA, detecting the control code to effect control signaling transparently over the voice channel..

6. The method of claim 1 including determining whether an incoming request is in the first format or a different format.

7. The method of claim 1 wherein the merchant financial verification request includes information about a credit card transaction.

8. A wireless financial transaction verification facility comprising:
a transaction information terminal operable to communicate information in a first format;
a converter connected to the recording device and operable to convert information between the first format and a second format;
a wireless communication device connected to the converter and to a digital cellular network, and operable to communicate with the network in the second format.

9. The facility of claim 8 wherein the terminal includes a card scanner.

10. The facility of claim 8 wherein the terminal includes an input device operable for entry of a transaction amount.

11. The facility of claim 8 wherein the terminal includes a display for displaying a received approval status message.

12. The facility of claim 8 wherein the converter is a remote communications apparatus for voice and data communication exclusively over the audio traffic channel of a digital wireless telecommunication network comprising:
a source for generating digital data;
a tone generation module for encoding the digital data into a series of audio frequency tones; the audio fragment tones being selected so as to avoid frequencies that are characteristic of human voice thereby minimizing interference with simultaneous voice traffic on the channel;
a voice/data signal encoder/decoder (vocoder) for sampling the audio frequency tones and forming digital signals for transmission over the digital wireless telecommunication network; and
a transmission system for transmitting the digital signals over the audio traffic channel of the digital wireless telecommunication network.

13. The facility of claim 8 wherein the wireless communication device is a digital cellular telephone.

14. A telecommunications system for financial transaction verification comprising:
a digital cellular network;
a financial verification facility having a central converter connected to the network, and operable to convert an incoming signal from a first format to a second format; and
the facility having a central processor operable to read the signal in the second format and to make a financial determination about transaction information contained in the signal.

15. The system of claim 14 wherein the processor is operable to generate a transaction approval indication response in the second format.

16. The system of claim 14 wherein the central converter is operable to convert an outgoing signal from the second format to the first format.

17. The system of claim 14 including a user communication system including a user terminal operable to convert financial transaction information to a signal in the second format, a user converter connected to the user terminal and operable to convert the signal to the first format, and a cellular device connected to the user converter and the network, and operable to communicate the signal in the first format to the call center.

18. The system of claim 18 wherein the user converter and the central converter are operably equivalent.

19. The system of claim 14 wherein the user converter is a remote communications apparatus for voice and data communication exclusively over the audio traffic channel of a digital wireless telecommunication network comprising:
a source for generating digital data;
a tone generation module for encoding the digital data into a series of audio frequency tones; the audio fragment tones being selected so as to avoid frequencies that are characteristic of human voice thereby minimizing interference with simultaneous voice traffic on the channel;
a voice/data signal encoder/decoder (vocoder) for sampling the audio frequency tones and forming digital signals for transmission over the digital wireless telecommunication network; and
a transmission system for transmitting the digital signals over the audio traffic channel of the digital wireless telecommunication network.
